(19) United States
(12) Patent Application Publication
(10) Pub. No.: US 2025/0202310 A1
(43) Pub. Date: Jun. 19, 2025

(54) SEAL ASSEMBLY

(71) Applicant: DAYTON-PHOENIX GROUP, INC., Dayton, OH (US)

(72) Inventors: Joseph Andrew Zahora, Dayton, OH (US); Joel Keith Knepper, Dayton, OH (US)

(21) Appl. No.: 18/975,238

(22) Filed: Dec. 10, 2024

Related U.S. Application Data
(60) Provisional application No. 63/610,478, filed on Dec. 15, 2023.

(51) Int. Cl. H02K 5/10; F16J 15/32; H02K 5/173

(52) U.S. Cl. CPC H02K 5/10; F16J 15/32; H02K 5/1735

(57) ABSTRACT

A system including a seal assembly having a casing defining a cavity therein, and a pair of radial shaft seals positioned in the cavity. The casing is configured to be removably mounted on a shaft such that each radial shaft seal sealingly engages the shaft.

This application claims priority to U.S. Provisional Application Ser. No. 63/610,478, filed on Dec. 15, 2023 and entitled Seal Assembly, the entire contents of which are hereby incorporated by reference.

The current disclosure is directed to a seal assembly, and more particularly, to a seal assembly that can be mounted on a shaft to block contaminants.

### BACKGROUND

Seal assemblies are often mounted onto shafts, such as a motor shafts. However many existing seal assemblies do not provide sufficient sealing. In addition, many existing seal assemblies are not able to be easily removed, inspected and/or replaced, which can lead to increased contamination and greater repair/down times.

### SUMMARY

In one embodiment the current disclosure is directed to a seal assembly that provides improved blockage of contaminants and/or a modular arrangement in which at least part of the seal assembly can be removed, inspected and/or replaced. More particularly, in one embodiment the invention is a system including a seal assembly having a casing defining a cavity therein and a pair of radial shaft seals positioned in the cavity. The casing is configured to be removably mounted on a shaft such that each radial shaft seal sealingly engages the shaft.

### BRIEF DESCRIPTION OF THE DRAWINGS

FIG. 1 is a front perspective view of a motor with a seal system at one end thereof;

FIG. 2 is a side cross section of the motor of FIG. 1;

FIG. 3 is a detail view of the area indicated in FIG. 2;

FIG. 4 is an exploded view of the seal system and end mount of the motor of FIG. 1;

FIG. 5 is a side cross section of the modular seal assembly of the seal system of FIG. 3;

FIG. 6 is an exploded view of the modular seal assembly of FIG. 5;

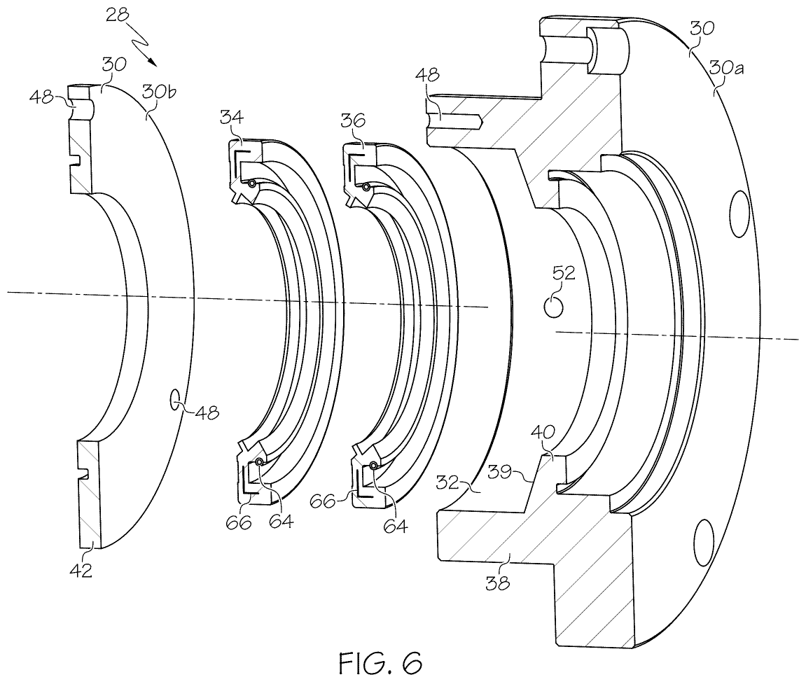

FIG. 7 is a side cross section of a radial shaft seal of the modular seal assembly of FIG. 5; and

FIG. 8 is a side cross section of an outer V-ring seal of the seal system of FIG. 3.

### DETAILED DESCRIPTION

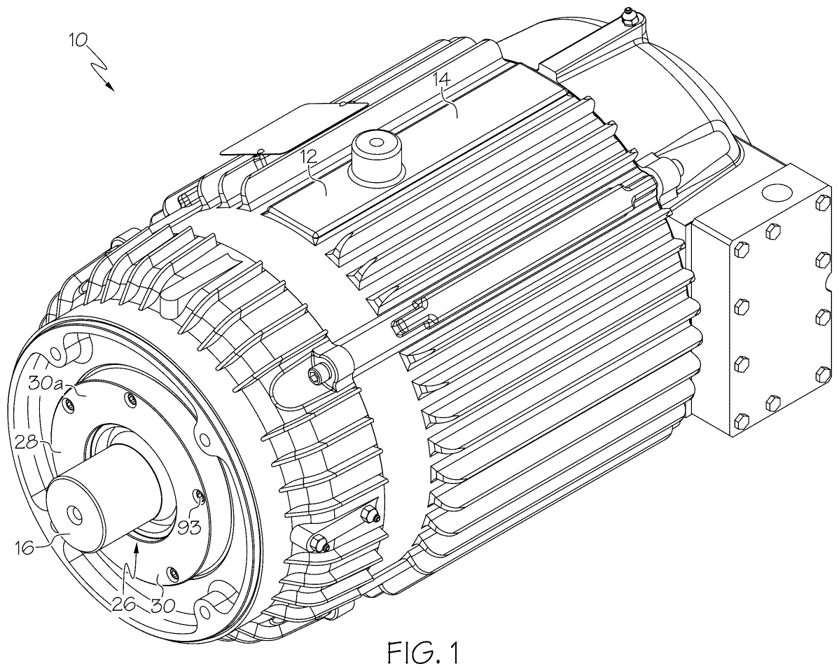

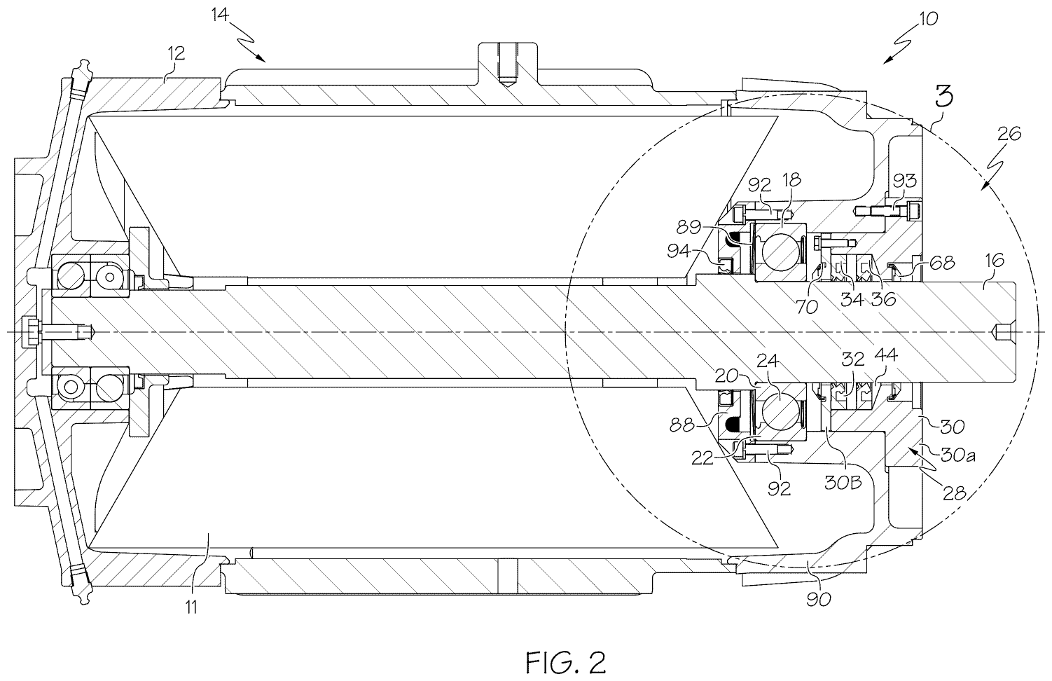

With reference to FIGS. 1 and 2, a system or motor assembly, generally designated 10, is show therein. The motor assembly 10 can include a motor 12 having a motor body 14 with a set of conductive wire windings, magnets, rotors and/or stators (schematically, and collectively, shown as components 11) that are configured to drive/rotate an output shaft 16 about its center axis when sufficient power is provided to the motor 12. The motor 12 can be an AC motor or a DC motor or any other type of motor as desired. It should be noted that, in certain embodiments, the motor 12 and/or shaft 16 are mounted/arranged vertically or generally vertically with the shaft 16 protruding from a bottom end thereof, but the various attached figures may shown the motor 12 and shaft 16 in a horizontal configuration for ease of illustration.

The system 10 can include a bearing 18 at one end thereof that has a radially inner race 20 that is rotatably coupled to the shaft 16, and a radially outer race 22 that is not rotatably coupled to, and/or is rotatably stationary relative to, the shaft 16. The bearing 18 includes a set of ball or rollers 24 positioned between the races 20, 22 to guide rotation of the shaft 16. The system/motor assembly 10 can include a seal system 26 located on the shaft 16 and configured to prevent contaminants from reaching the bearing 18 and/or the body 14 and/or components 11 of the motor 12.

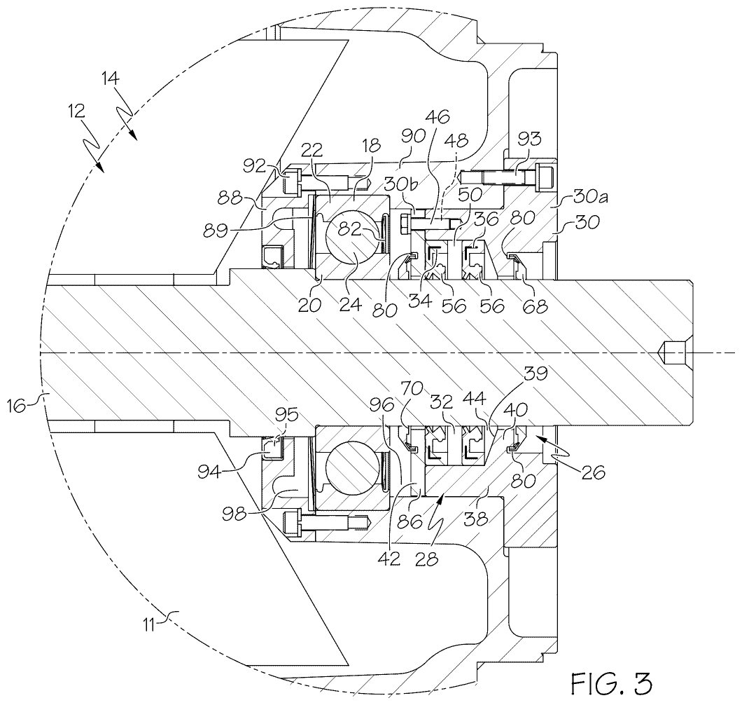

The seal system 26 can be located at a distal/outer end of the shaft 16. For the purposes of this document, it should be understood that, with regard to axial positioning, the “outer” or distal end, is located at or toward the distal end of the shaft 16 (in one case, to the right of bearing 18 or bearing locking plate 88 in FIGS. 2 and 3) and away from the body 14/components 11 of the motor 12, while the “inner” end or axial direction is located away from the distal end of the shaft 16 (to the left of bearing 18 or outer V-ring seal 68 in FIGS. 2 and 3) and closer to or adjacent to the body 14/component 11 of the motor 12.

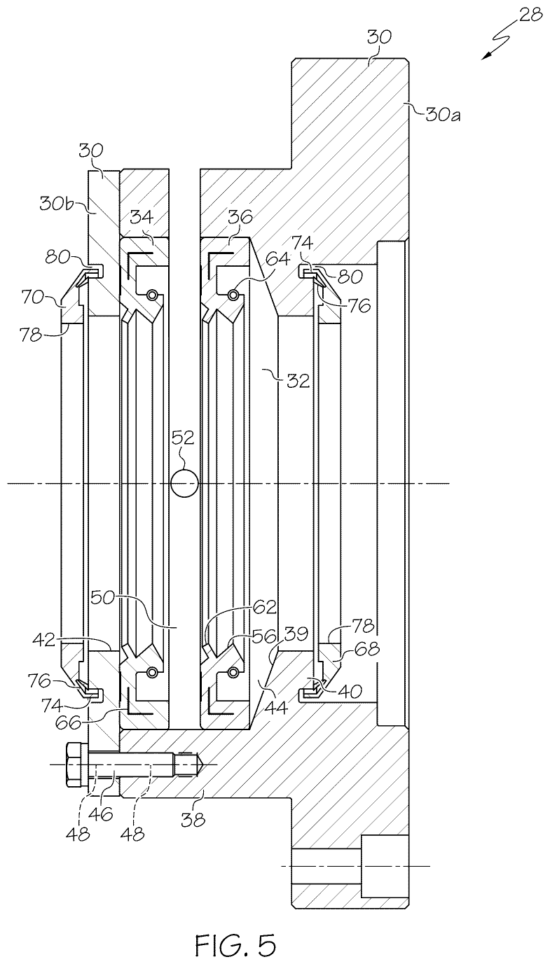

With reference to FIG. 5, the seal system 26 can include a modular seal assembly 28 which can include an annular casing 30 defining a cavity 32 therein, with a pair of radial shaft seals 34, 36 positioned in the cavity 32 and contained therein. The casing 30 can having an annular side wall 38 and an axially outer flange 40 in the cavity 32 at or adjacent to an outer axial end. The casing 30 can also have an axially inner flange 42 in the cavity 32 at or adjacent to the opposite, inner axial end thereof. In the illustrated embodiment, an axially inner surface 39 of the outer flange 40 is angled axially outwardly, moving in the radially inner direction. In this manner the outer flange 40 is at least partially spaced away from the adjacent radial shaft seal 36 to define a compartment 44 between the outer flange 40 and the casing 30.

In one case the casing 30 is made of two separable portions, including a first or axially outer portion 30a that includes the outer flange 40 and the side wall 38, and a second or axially inner portion 30b that includes or defines the inner flange 42. The first 30a and second 30b portions can be removably coupled together, for example via a set of fasteners 46 that extend through aligned holes 48 of the first 30a and second 30b portions. In this manner the casing 30 has a separable portion 30b that is removably coupled to a remainder 30a of the casing 30 to provide access to the cavity 32. The casing 30 can be made of a relatively stiff/strong material that is corrosion resistant, such as metal (including ferrous metals such as steels, stainless steel and the like) but may in certain cases be made of other material such as polymers, plastic, composites, fiberglass, etc.

In the illustrated embodiment one of the radial shaft seals 36 (the axially outer radial shaft seal 36) is positioned adjacent to, and in contact with, a base end of the outer flange 40, and the other radial shaft seal 34 (the axially inner radial shaft seal 34) is positioned adjacent to and in facial contact with the inner flange 42. The radial shaft seals 34, 36 can be spaced apart in the axial direction, and define a space or compartment 50 therebetween. The radial shaft seals 34, 36 can be arranged and positioned such that a radially outer surface of each radial shaft seal 34, 36 is in sealing engagement, via an interference fit in one case, with a radially inner surface of the side wall 38/casing 30. The interference fit can retain the radial shaft seals 34, 36 in the illustrated positions, and maintain the integrity of the compartment 50.

In the illustrated embodiment, the casing 30 has a grease port 52 extending from a radially outer surface of the casing 30 to the inner cavity 32/compartment 50 to enable grease to be introduced into the compartment 50. In the illustrated embodiment, the grease port 52 is axially aligned with the compartment 50 so that grease can be directly injected into, and fill, the compartment 50.

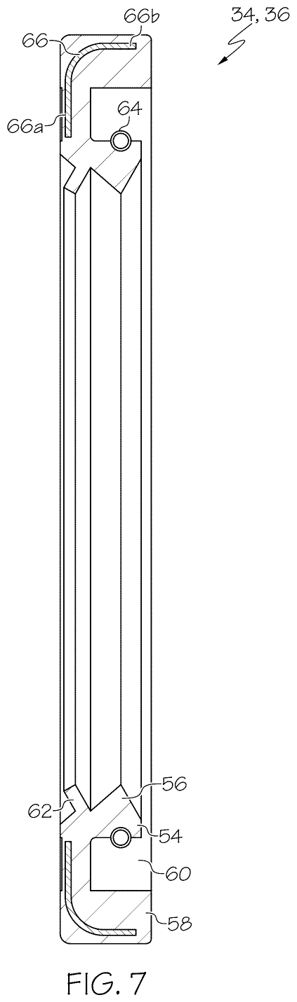

As best shown in FIG. 7 each radial shaft seal 34, 36 can include a body 54 having a contact lip 56 on a radially inner surface thereof and an outer lip 58 on a radially outer surface thereof, defining a gap 60 therebetween. Each body 54 can be made of a relatively soft, deformable and/or pliable material in one case, such as rubber, synthetic rubber (including fluorine rubber (FKM), fluoroelastomers, or nitrile rubber), elastomers and the like. Each body 54 can also include an auxiliary, non-contact lip 62 on a radially inner surface thereof but spaced axially inwardly relative to the contact lip 56.

Each radial shaft seal 34, 36 can include a circumferentially extending spring 64 extending entirely around, and positioned radially outside of, the contact lip 56. In particular each spring 64 is positioned on a radially outer surface of the contact lip 56. The spring 64 can take the form of an annular coil spring, or other resilient component, that is configured to bias the contact lip 56 to a radially inner position. For example, the contact lip 56 may receive the shaft 16 therein (FIG. 3) wherein the shaft 16 has a slightly larger diameter than the inner diameter of the contact lip 56. Thus when the shaft 16 is received in the radial shaft seal 34, 36, the associated contact lip 56 is deformed slightly in the radially outward direction to accommodate the shaft 16, and the spring 64 biases the contact lip 56 radially inwardly to ensure a good seal with the shaft 16. The springs 64 also help to ensure good contact with the shaft 16 in the event that the radial shaft seal 34, 36 and/or shaft 16 should become somewhat cocked (e.g. their central axis are arranged at an angle and are not parallel). The non-contact lip 62 of reach radial shaft seal 34, 36 can provide further sealing capabilities by preventing relatively larger particles or debris from moving past the non-contact lip 62 and/or by helping to retain grease in place.

Each radial shaft seal 34, 36 can also include a stiffening member 66 in the outer lip 58 and positioned radially outside the spring 64. Each stiffening member 66 is embedded in the body 54 in the illustrated embodiment, and positioned radially outside the contact lip 56. Each stiffening member 66 can be generally “L” shaped in cross section/end view, having a first portion 66a aligned in/along a radial plane and a second portion 66b aligned in/along a circumferential plane.

The stiffening member 66 (and the spring 64) can be made of a relatively stiff material, such as steel or the other materials outlined above as materials for the casing 30. Thus the body 54 of each radial shaft seal 34, 36 can be made of a material that has greater pliability than the spring 64 and/or the stiffening member 66. Each radial shaft seal 34, 36 can be fixed in place such that during rotation of the shaft 16, the shaft 16 rotates relative to the radial shaft seals 34, 36, and the contact lips 56 sealingly engage the shaft 16 to provide a seal to the seal system 26/modular seal assembly 28 and reduce the amount of contaminant from reaching the bearing 18.

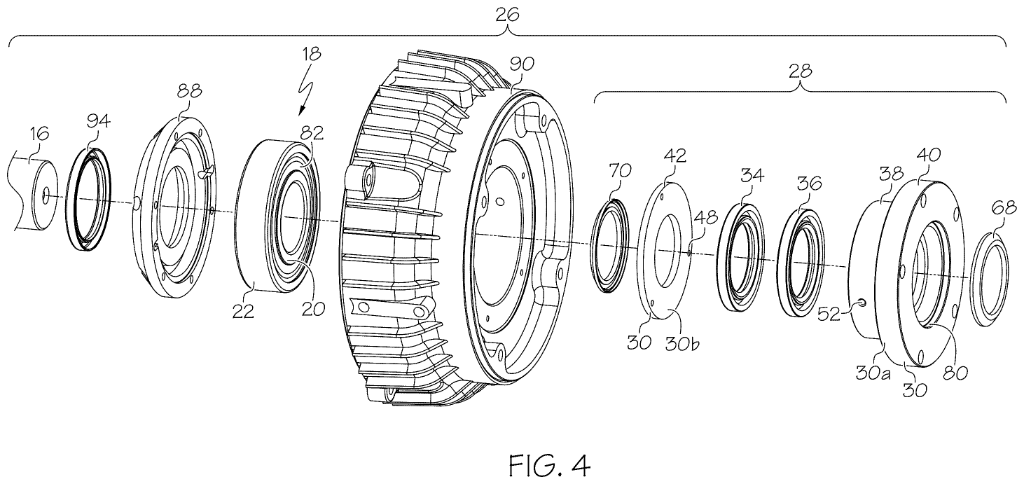

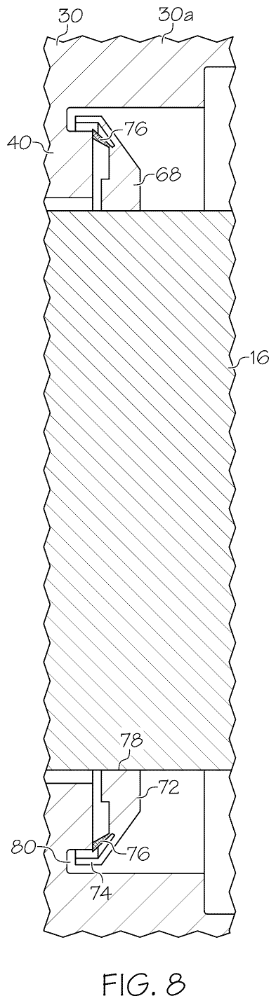

With reference to FIGS. 3-5, the seal system 26/modular seal assembly 28 can include an axially outer V-ring seal 68 mounted on an axially outer surface of the casing 30/outer flange 40, and an axially inner V-ring seal 70 mounted on an axially inner surface of the casing 30/inner flange 42. Both V-ring seals 68, 70 can be positioned externally of the cavity 32. With reference to FIG. 8, each V-ring seal 68, 70 can have a relatively rigid frame 72 that is generally “U” shaped in cross section, defining an outer flange 74. Each V-ring seal 68, 70 further includes a relatively pliable sealing lip 76 received in the frame 72 and coupled thereto.

Each V-ring seal 68, 70 can be mounted on the shaft 16 via an interference fit between the radially inner surface 78 of the frame 72 and the radially outer surface of the shaft 16 such that each V-ring seal 68, 70 is rotatably coupled to, and rotates with the shaft 16. As can be seen in FIG. 8, the outer flange 74 of the V-ring seal 68, 70 is received in a circumferentially-extending groove 80 formed on an outer/inner surface of the casing 30 respectively (also see FIG. 5). Each frame 72 of each V-ring seal 68, 70 can be made of the same or similar materials as identified above for the springs 64 of the radial shaft seals 34, 36, and each sealing lip 76 can be made of the same or similar materials as identified above for the body 54 of the radial shaft seals 34, 36. Each sealing lip 76 rotatably and sealingly engages the casing 30 to act as a wiper and provide a further seal to the seal system 26/modular seal assembly 28 and reduce the amount of contaminants reaching the bearing 18.

With reference to FIG. 3, the bearing 18 can, in one case, be a sealed bearing having a bearing seal 82 extending in the radial direction between the inner race 20 and the outer race 22. In the illustrated embodiment the bearing seal 82 is rotatably coupled to the inner race 20 and not rotatably coupled to the inner race 22, and the radially inner end of the bearing seal 82 is rotatably received in a groove 86 formed on the outer race 22 to provide a sealing arrangement. The bearing seal 82 can be made of the same or similar materials as identified above for the body 54 of the radial shaft seal(s) 34, 36. In the illustrated embodiment, the axially outer side of the bearing 18 includes the bearing seal 82, but the axially inner side of the bearing 18 does not include a bearing seal 82. This arrangement can be useful when the system 10 is used in a vertical configuration, as the bearing seal 82 will help to block grease from dripping/flowing vertically downward due to the gravity and thereby escape from the bearing 18, but allows grease to enter the bearing 18 from an upper location/direction.

With reference to FIGS. 2-4, the system 10/seal system 26 can include a bearing locking plate 88, with a wave washer 89 positioned between the bearing locking plate 88 and the bearing 18. The wave washer 89 engages the bearing 18 (the outer race 22, in the illustrated embodiment), and preloads/biases the bearing 18 in the axially outer direction to ensure the bearing 18 is located in the proper axial position. In the illustrated embodiment the bearing locking plate 88 is not rotationally coupled to the shaft 16 and is coupled to an axially inner end of an end mount 90 of the motor body 14 via fasteners 92. The seal module 28/casing 30 is, in turn, coupled to an axially outer end of the end mount 90 via fasteners 93. The system 10/seal system 26 can include a bearing plate radial shaft seal 94 positioned in a groove 95 on the axially inner surface of the bearing locking plate 88, positioned axially inwardly relative to at least part of the bearing locking plate 88. The radial shaft seal 94 can thus be positioned axially inward of at least part of, and in contact with, the bearing locking plate 88, and in sealing contact with the shaft 16, to help block contaminants from reaching the inner components 11/windings, rotor, stator, etc. of the motor 12.

With reference to FIG. 3, when the seal system 26 is mounted onto the motor 12/shaft 16, the compartment 50 between radial shaft seals 34, 36 is filled with grease, as outlined above. In addition, during assembly of the modular seal assembly 28, the compartment 44 between the outer flange 40 of the casing 30 and the outer radial shaft seal 36 can be filled with grease. In addition, the compartment 96 between the axial outer surface of the bearing 18 and the axially inner surface of casing 30 can be filled with grease, and the compartment 98 between the axial inner surface of the bearing 18 and the axially outer surface of the bearing locking plate 88 can be filled with grease.

In this manner the grease filled compartments 50, 44, 96, 98, along with the seals 34, 36, 68, 70, provide multiple barriers arranged in series to reduce the amount of contaminants reaching the bearing 18. In particular, moving from an axially outside-in direction (right to left in FIG. 3), contaminants are first blocked by the V-ring 68; and then blocked by grease in the compartment 44; then by the outer radial shaft seal 36; then by grease in the compartment 50; then by the inner radial shaft seal 34; then by the V-ring 70; then by grease in the compartment 96, and finally by the bearing seal 82. In addition, continuing to move axially inwardly, grease in the compartment 98, and the radial shaft seal 94, reduce the amount of contaminants reaching the inner components 11/body 14 of the motor 12.

The seal system 26, and in particular the modular seal assembly 28, also provide a seal system that reduces the ingress of contaminants but is easy to access, service, repair and/or replace. In particular, as noted above, the modular seal assembly 28 is removably secured to the body 14 of the motor 12 via fasteners 93, which are accessible from outside the motor 12 as shown in FIG. 1. When it is desired to access the modular seal assembly 28, the fasteners 93 can be removed and the modular seal assembly 28, along with the V-rings 68, 70 coupled thereto, lifted off of the shaft 16. The V-rings 68, 70 can then be repaired, replaced or serviced. The modular seal assembly 28 is thereby configured to be mounted on the shaft 16 as a unit, and configured to be removed from the shaft 16 as a unit, for ease of assembly and maintenance.

In addition, with reference to FIG. 5, the inner flange 42/second portion 30b of the modular seal assembly 28 can be removed by removing the fasteners 46, thereby unassembling the modular seal assembly 28 and providing access to the inner cavity 32 and the radial shaft seals 34, 36. The radial shaft seals 34, 36 can then be repaired, replaced or serviced, and the compartments 50, 44, 96, 98 filled with grease. In addition, if desired, a number of replacement modular seal assemblies 28, that are stocked in inventory and ready to be used, can be maintained on hand. An inventoried, ready-to-use modular seal assembly 28 can quickly replace an in-use modular seal assembly 28, and the removed modular seal assembly 28 can be set aside of repair or servicing a later time, which reduces down-time of the motor 12.

Although the invention is shown and described with respect to certain embodiments, it should be clear that modifications will occur to those skilled in the art upon reading and understanding the specification, and the present invention includes all such modifications.

1. A system including a seal assembly comprising:
a casing defining a cavity therein; and
a pair of radial shaft seals positioned in the cavity, wherein the casing is configured to be removably mounted on a shaft such that each radial shaft seal sealingly engages the shaft.

2. The system of claim 1 wherein the casing has an annular side wall, an outer flange and an inner flange, wherein one of the radial shaft seals is positioned adjacent to the outer flange and the other radial shaft seal is positioned adjacent the inner flange, and wherein a radial outer surface of each radial shaft seal is in sealing engagement with a radially inner surface of the side wall.

3. The system of claim 2 wherein the casing includes a first portion, including the outer flange and the side wall, and a second portion, including the inner flange, and wherein the first and second portions are removably coupled together.

4. The system of claim 2 wherein the outer flange is at least partially spaced away from the adjacent radial shaft seal to define a compartment therebetween.

5. The system of claim 1 wherein the radial shaft seals are spaced apart in an axial direction to define a compartment therebetween.

6. The system of claim 5 wherein the casing includes a grease port extending from a radially outer surface of the casing to the compartment.

7. The system of claim 1 wherein each radial shaft seal includes a body having a contact lip on a radially inner surface thereof and a spring configured to bias the contact lip to a radially inner position.

8. The system of claim 7 wherein the spring of each radial shaft seal is positioned radially outside the contact lip, and wherein each radial shaft seal further includes a stiffening member positioned radially outside the spring.

9. The system of claim 8 wherein each body is made of a material that has greater pliability than the associated spring and stiffening member, wherein the stiffening member has a first portion aligned in a radial plane and a second portion aligned in a circumferential plane, and wherein each radial shaft seal includes an outer lip defining a gap between the outer lip and the contact lip in the axial direction.

10. The system of claim 1 wherein the casing contains and retains the radial shaft seals therein, and is configured to retain grease therein, and wherein the casing is configured to be unassembled to provide access to the radial shaft seals therein.

11. The system of claim 1 wherein the casing and pair of shaft seals together form a modular seal assembly that is configured to be mounted on the shaft as a unit, and configured to be removed from the shaft as a unit.

12. The system of claim 1 further comprising an inner V-ring seal positioned on an axially inner side of the casing, external of the cavity, and an outer V-ring seal positioned on an axially outer side of the casing, external of the cavity, wherein each V-ring seal is configured to be rotationally mounted on the shaft and to sealingly engage the casing.

13. The system of claim 12 wherein the casing has an annular side wall, an outer flange at one axial end and an inner flange at an opposite axial end thereof, wherein the inner flange and the outer flange each have a circumferentially-extending groove therein, and wherein at least part of each V-ring seal is received in an associated groove.

14. The system of claim 12 wherein each V-ring seal includes a relatively rigid frame and a relatively pliable sealing lip.

15. The system of claim 1 further comprising a rotational shaft, and wherein the seal assembly is mounted on the shaft such that each radial shaft seal sealingly engages the shaft.

16. The system of claim 15 further comprising a sealed bearing mounted on the shaft and positioned axially inwardly relative to the seal assembly.

17. The system of claim 16 further comprising a bearing locking plate in engagement with an outer race of the bearing and positioned axially inwardly relatively to the bearing.

18. The system of claim 17 further comprising a bearing plate radial shaft seal coupled to the bearing locking plate in sealing engagement with the shaft, and positioned axially inwardly relative to at least part of the bearing locking plate.

19. The system of claim 15 further comprising a motor, wherein the shaft is an output shaft of the motor, and wherein the motor and shaft are vertically aligned.

20. A system including a seal assembly comprising:
a casing having an annular side wall, an outer flange at or adjacent to one axial end and an inner flange at or adjacent to an opposite axial end thereof, the casing having an inner cavity, wherein the casing has a separable portion that is removably coupled to a remainder of the casing to provide access to the cavity; and
a pair of radial shaft seals configured to be positioned in the cavity, wherein the casing is configured to be removably mounted on a shaft such that each radial shaft seal sealingly engages the shaft.

21. A method comprising:
accessing a system including a seal assembly having a casing defining a cavity therein, and a pair of radial shaft seals positioned in the cavity; and
removably mounting the casing on a shaft such that each radial shaft seal sealingly engages the shaft.
